(19) United States
(12) Patent Application Publication
(10) Pub. No.: US 2018/0361574 A1
(43) Pub. Date: Dec. 20, 2018

(54) INTELLIGENT DIGITAL CONTROLLER OF FLEXIBLE MATERIAL CUTTING ROBOT AND REALIZATION METHOD

(71) Applicants: Foshan Shike Intelligent Technology co. LTD, FOSHAN (CN); GUANGDONG UNIVERSITY OF TECHNOLOGY, GUANGZHOU (CN)

(72) Inventors: YAOHUA DENG, GUANGZHOU (CN); QIWEN LU, FOSHAN (CN); XIALI LIU, FOSHAN (CN)

(73) Assignees: Foshan Shike Intelligent Technology co., LTD; GUANGDONG UNIVERSITY OF TECHNOLOGY

(21) Appl. No.: 15/989,198

(22) Filed: May 25, 2018

(30) Foreign Application Priority Data
Jun. 20, 2017 (CN) 201710469626.0

(51) Int. Cl. B25J 9/16; B25J 9/00; B25J 11/00

(52) U.S. Cl. CPC B25J 9/1602; B25J 9/0009; B25J 9/1664; G05B 2219/31151; G05B 2219/45068; G05B 2219/40052; Y10S 901/02; B25J 11/0055

(57) ABSTRACT

An intelligent digital controller of a flexible material cutting robot and a realization method are provided. The controller comprises: an ARM chip, a servo driver bus communication module and a CPLD module. The ARM chip has built-in two processor cores (Cortex-M0 and Cortex-M4) and is externally connected with a flash memory, an SD card, SRAMs and an Ethernet physical transceiver_2; the Cortex-M0 reads a corresponding graph in the SD card into SRAM_1 according to a graph number, and sends a graph data readiness interruption request to an interruption controller; and after the interruption request is responded, Cortex-M4 reads in graph data and conducts interpolation calculation on the graph; the servo driver bus communication module is used to receive an interpolation calculation result and transmit the calculation result to a data input end of a servo driver with a corresponding address number through a data sending port.

### CROSS-REFERENCE TO RELATED APPLICATIONS

This application claims priority to Chinese Patent Application No. CN1710469626.0 with a filing date of Jun. 20, 2017. The content of the aforementioned applications, including any intervening amendments thereto, are incorporated herein by reference.

### TECHNICAL FIELD

The present invention relates to the field of intelligent digital controllers, and particularly relates to a network-based multi-core collaborative intelligent digital controller of a flexible material cutting robot and a realization method thereof.

### BACKGROUND OF THE PRESENT INVENTION

The existing flexible material cutting robot generally adopts a pulse type motion controller which has complicated wiring, low efficiency, high equipment failure rate and high maintenance cost. In addition, there are different interface types for different drivers, analog quantities and IO interface boards, causing poor compatibility and stability of a control system. With the continuous improvement of production requirements and the improvement of production efficiency and processing precision, the quantity of control shafts is continuously increased, while the existing digital controller can only increase the quantity of the control shafts by increasing expansion cards and causes heavy workload of hardware and software modification. Therefore, a network-based digital controller with easy expansion, good stability and guarantee of high data transmission rate and accuracy rate shall be designed.

### SUMMARY OF PRESENT INVENTION

To solve the above technical problems, the present invention aims to provide a network-based multi-core collaborative intelligent digital controller of a flexible material cutting robot and a realization method.

The purpose of the present invention is achieved through the following technical solution:

An intelligent digital controller of a flexible material cutting robot is provided. The controller is a network-based multi-core collaborative intelligent digital controller which comprises: an ARM chip, a servo driver bus communication module and a CPLD (Complex Programmable Logic Device) module; the ARM chip has two built-in processor cores (Cortex-M0 and Cortex-M4) and is externally connected with a flash memory, an SD (Secure Digital) card, SRAMs (Static Random Access Memories) and, an Ethernet physical transceiver_2; the Cortex-M0 reads, a corresponding graph in the SD card into SRAM_1 according to a graph number, and sends a graph data readiness interruption request to an interruption controller; and after the interruption request is responded, Cortex-M4 reads in graph data and conducts interpolation calculation on the graph; the servo driver bus communication module is used to receive an interpolation calculation result and transmit the calculation result to a data input end of a servo driver with a corresponding address number through a data sending port; and the CPLD module is used to read original point, terminal point and limit signals of a machine tool and store the read signal values in a shared space specified by SRAM_1.

A realization method for the intelligent digital controller of the flexible material cutting robot is provided. The method is realized based on a network-based multi-core collaborative intelligent digital controller and comprises: reading, by the Cortex-M0, a corresponding graph in the SD card into SRAM_1 according to a graph number, and sending a graph data readiness interruption request to an interruption controller; reading in, by Cortex-M4, graph data and conducting interpolation calculation on the graph; and sending, by a data bus, a calculation result to a servo driver bus communication module; and transmitting, by a data sending port, the interpolation calculation result to a data input end of a servo driver with a corresponding address number.

Compared with the prior art, one or more embodiments of the present invention may have the following advantages:

The controller is connected with all the servo drivers through a network, line, and the driver each is connected in series through the network line, thus fewer connecting lines are used, interference is less and data communication speed is rapid, the probability of data loss is very low, and the controller is easier to realize high-speed, high-precision and collaborative control of a servo system than a pulse control mode.

### DESCRIPTION OF THE DRAWINGS

FIG. 1 is a structural schematic diagram of an intelligent digital controller of a flexible material cutting robot; and

FIG. 2 is a structural schematic diagram of inter-core interruption of an intelligent digital controller.

### DETAILED DESCRIPTION OF PREFERRED EMBODIMENTS

In order to make the purpose, the technical, solution and the advantages of the present invention more clear, the present invention will be further described in detail below in combination with embodiments and attached drawings.

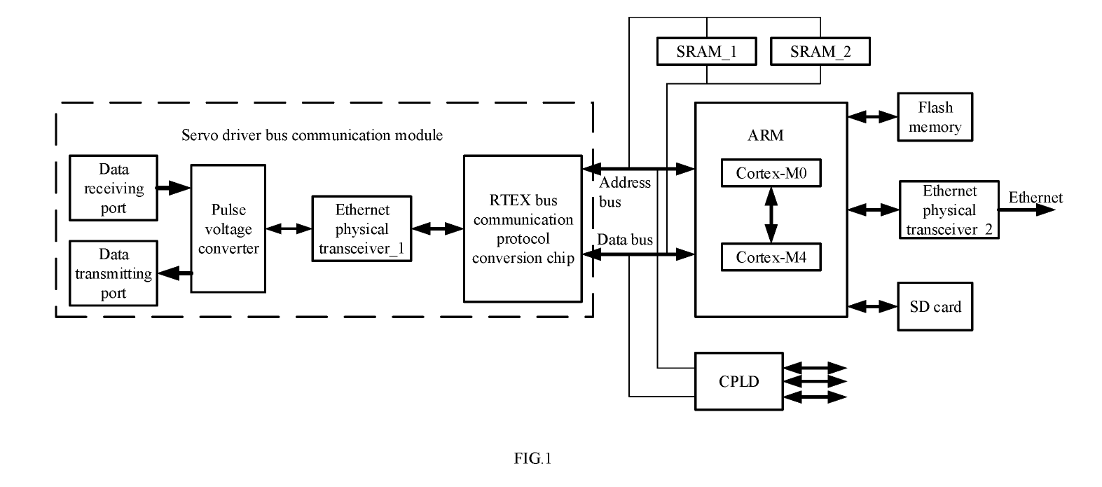

FIG. 1 shows an intelligent digital controller structure of a cutting robot. The controller is a network-based multi-core collaborative intelligent digital controller which comprises: an ARM chip, a servo driver bus communication module and a CPLD module. The ARM chip has two built-in processor cores (Cortex-M0 and Cortex-M4) and is externally connected with a flash memory, an SD card, SRAMs and an Ethernet physical transceiver_2. The Cortex-M0 reads a corresponding graph in the SD card into SRAM_1 according to a graph number, and sends a graph data readiness interruption request to an interruption controller; and after, the interruption request is responded, Cortex-M4 reads in graph data and conducts interpolation calculation on the graph. the servo driver bus communication module is used to receive an interpolation calculation result and transmit the calculation result to a data input end of a servo driver with a corresponding address number through a data sending port. The CPLD module is used to read original point, terminal point and limit signals of a machine tool and store the read signal values in a shared space specified by SRAM_1.

The type of the ARM chip may be LPC4357. The Cortex-M0 is, a main control core, and Cortex-M4 is used for interpolation motion control. Two SRAMs are arranged.

The above Cortex-M0 and Cortex-M4 realize data exchange in a memory sharing mode, and perform collaborative work in an inter-core interruption mode; and the inter-core interruption is controlled by the interruption controller.

The above servo driver bus communication module comprises an Ethernet physical transceiver_1 and an RTEX (Realtime Express) bus communication protocol conversion chip; and the RTEX bus communication protocol conversion chip is connected with the ARM chip through address buses and data buses.

The above ARM chip is connected with the RTEX bus communication protocol conversion chip through 11 address buses and 32 data buses.

The above CPLD module is also used for input/output port expansion, and is connected with the ARM chip through 16 address buses and 16 data buses.

The above ARM chip is also connected with an external Ethernet through an Ethernet physical transceiver_2.

The above servo driver bus communication module further comprises a pulse voltage converter, a data receiving port and a data sending port.

The pulse voltage converter is connected with the Ethernet physical transceiver_1, and realizes level conversion with the Ethernet physical transceiver_1.

The data receiving port and the data sending port are respectively connected with the pulse voltage converter.

The type of the Ethernet physical transceiver_1 may be DP83848VVVBI. The type of the pulse voltage converter may be TLA-6T118LF series.

The present embodiment further discloses a realization method for the intelligent digital controller of the flexible material cutting robot. The method is realized based on a network-based multi-core collaborative intelligent digital controller and, comprises: reading, by the Cortex-M0, a corresponding graph in the SD card into SRAM_1 according to a graph number, and sending a graph data readiness interruption request to an interruption controller; sending, by a data bus, a calculation result to a servo driver bus communication module; and transmitting, by a data sending port, the interpolation calculation result to a data input end of a servo driver with a corresponding address number.

The Cortex-M4 reads in the graph data and conducts interpolation calculation on the graph to complete interpolation motion control. In the process of interpolation motion. Cortex-M0 reads original point, terminal point and limitation signals of a machine tool through the CPLD module and stores the read signal values in a shared space specified by SRAM_1. When the signal value is true, Cortex-M0 sends a corresponding interruption request; and after the interruption request is responded, Cortex-M4 suspends the interpolation motion according to the signal value and continues to make the interpolation motion when a signal state value is restored to the original value.

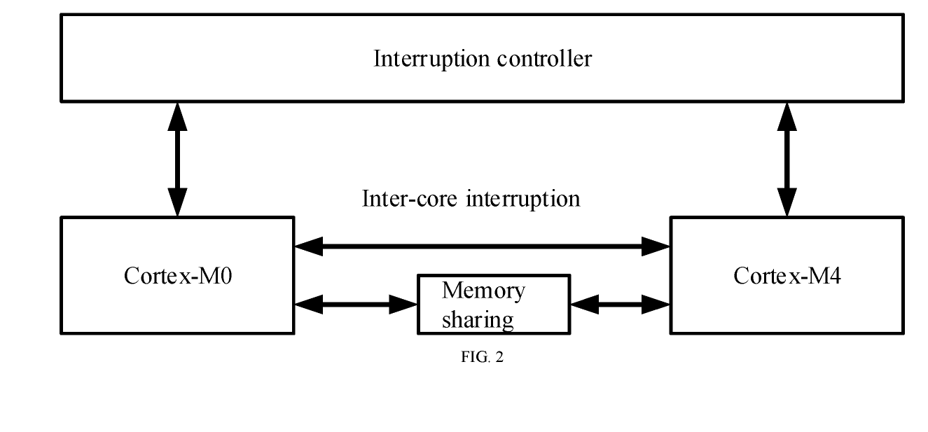

A flow of data exchange between Cortex-M4 and Cortex-M0 is sending the interruption request to the interruption controller, storing data to be exchanged in SRAM_1, responding to the interruption request reading the to-be-exchanged data stored in SRAM_1, and releasing an interruption permission (as shown in FIG. 2).

Although the present invention discloses the above embodiments, the described embodiments are only for the convenience of understanding the present invention, not for limiting the present invention. Any of those skilled in the art of the present invention can make any amendment and change to implementation forms and details without departing from the spirit and scope disclosed by the present invention. However, the protection scope of the patent of the present invention shall depend on the scope defined by appended claims.

We claim:

1. An intelligent digital controller of a flexible material cutting robot, the controller being a network-based multi-core collaborative intelligent digital controller and comprising: an ARM chip, a servo driver bus communication module and a CPLD module; wherein
the ARM chip has two built-in processor cores (Cortex-M0 and Cortex-M4) and is externally connected with a flash memory, an SD card, SRAMs and an Ethernet physical transceiver_2; the Cortex-M0 reads a corresponding graph in the SD card into SRAM_1 according to a graph number, and sends a graph data readiness interruption request to an interruption controller; and after the interruption request is responded, Cortex-M4 reads in graph data and conducts interpolation calculation on the graph;
the servo driver bus communication module is used to receive an interpolation calculation result and transmit the calculation result to a data input end of a servo driver with a corresponding address number through a data sending port; and
the CPLD module is used to read original point, terminal point and limit signals of a machine tool and store the read signal values in a shared space specified by SRAM_1.

2. The intelligent digital controller of the flexible material cutting robot according to claim 1, wherein
a type of the ARM chip is LPC4357;
the Cortex-M0 is a main control core, and the Cortex-M4 is used for interpolation motion control; and
two SRAMs are arranged.

3. The intelligent digital controller of the flexible material cutting robot according to claim 2, wherein the Cortex-M0 and Cortex-M4 realize data exchange in a memory sharing mode, and perform collaborative work in an inter-core interruption mode; and the inter-core interruption is controlled by the interruption controller.

4. The intelligent digital controller of the flexible material cutting robot according to claim 1, wherein the servo driver bus communication module comprises an Ethernet physical transceiver_1 and an RTEX bus communication protocol conversion chip; and the RTEX bus communication protocol conversion chip is connected with the ARM chip through address buses and data buses.

5. The intelligent digital controller of the flexible material cutting robot according to claim 1, wherein the CPLD module is also used for input/output port expansion, and, is connected with the ARM chip through address buses and data buses.

6. The intelligent digital controller of the flexible material cutting robot according to claim 1, wherein the ARM chip is also connected with an external Ethernet through an Ethernet physical transceiver_2.

7. The intelligent digital controller of the flexible material cutting robot according to claim 1, wherein the servo driver bus communication module further comprises a pulse voltage converter, a data receiving port and a data sending port;
the pulse voltage converter is connected with the Ethernet physical transceiver_1, and realizes level conversion with the Ethernet physical transceiver_1; and
the data receiving port and the data sending port are respectively connected with the pulse voltage converter.

8. The intelligent digital controller of the flexible material cutting robot according to claim 1, wherein
a type of the Ethernet physical transceiver_1 is DP83848VVVBI; and
a type of the pulse voltage converter is TLA-6T118LF series.

9. A realization method for the intelligent digital controller of the flexible material cutting robot, the method being realized based on a network-based multi-core collaborative intelligent digital controller and comprising:
reading, by the Cortex-M0, a corresponding graph in the SD card into SRAM_1 according to a graph number, and sending a graph data readiness interruption request to an interruption controller;
reading in, by Cortex-M4, graph data and conducting interpolation calculation on the graph; and sending, by a data bus, a calculation result to a servo driver bus communication module; and
transmitting, by a data sending port, the interpolation calculation result to a data input end of a servo driver with a corresponding address number.

10. The realization method for the intelligent digital controller of the flexible material cutting robot according to claim 9, wherein the Cortex-M4 reads in the graph data and conducts interpolation calculation on the graph to complete interpolation motion control; in the process of interpolation motion, Cortex-M0 reads original point, terminal point and limit signals of a machine tool through the CPLD module and stores the read signal values in a shared space specified by SRAM_1; when the signal value is true, Cortex-M0 sends a corresponding interruption request; and after the interruption request is responded, Cortex-M4 suspends the interpolation motion according to the signal value and continues to make the interpolation motion when a signal state value is restored to the original value.
